(19) United States
(12) Patent Application Publication
(10) Pub. No.: US 2023/0302882 A1
(43) Pub. Date: Sep. 28, 2023

(54) DOOR STRUCTURE FOR VEHICLE

(71) Applicant: Honda Motor Co., Ltd., Tokyo (JP)

(72) Inventors: Yasuhisa EGAWA, Tokyo (JP); Yoshihiro Fujimura, Tokyo (JP); Atsushi Hasegawa, Saitama (JP); Ryota Taniwaki, Saitama (JP)

(73) Assignee: Honda Motor Co., Ltd., Tokyo (JP)

(21) Appl. No.: 18/165,328

(22) Filed: Feb. 7, 2023

(30) Foreign Application Priority Data
Mar. 23, 2022 (JP) 2022-047659

(51) Int. Cl. B60J 5/04

(52) U.S. Cl. CPC B60J 5/043; B60J 5/0429; B60J 5/0413; B60J 5/0415

(57) ABSTRACT

An inner panel of a door body includes an inner wall extending in a front-rear direction of a vehicle body on an inner side in a vehicle width direction, a connection wall extending toward an outer side in the vehicle width direction from the inner wall, and an outer wall extending in the front-rear direction of the vehicle body from an outer end of the connection wall in the vehicle width direction and joined to an outer panel. A door beam includes an arch-shaped beam body and a stay located on the outer side in the vehicle width direction with respect to an end of the beam body in a longitudinal direction. The rear end of the beam body is fixed to the inner wall. The stay has a front end fixed to the beam body and a rear end fixed to the outer wall.

### CROSS-REFERENCE TO RELATED APPLICATION

This application claims the priority benefits of Japanese application no. 2022-047659, filed on Mar. 23, 2022. The entirety of the above-mentioned patent application is hereby incorporated by reference herein and made a part of this specification.

### BACKGROUND

### Technical Field

The disclosure relates to a door structure for vehicle.

### Description of Related Art

For example, Patent Literature 1 (Japanese Patent Laid-Open No. 2005-138660) discloses that a door beam is provided inside a door of a vehicle, and the door beam is formed in an arch shape (curved shape) that the center of the door beam in the longitudinal direction is convex toward the outer side in the vehicle width direction.

In the conventional structure described in Patent Literature 1, the door beam is formed in an arch shape, so the load due to a collision (side impact) from a lateral side of the vehicle can be supported by the arch portion of the door beam. Therefore, as compared with a linear door beam, the resistance to a collision can be improved.

However, for a door structure having the conventional structure, if the door beam is displaced in the rotational direction around its end at the time when the load of a collision (side impact) acts on the center of the door beam, the bending moment acting on the door beam may increase. Therefore, there is a possibility that the reaction force of the door beam against the load cannot be increased sufficiently.

### SUMMARY

A door structure for vehicle according to the disclosure includes an inner panel (20) provided on an inner side in a vehicle width direction; an outer panel (30) provided on an outer side in the vehicle width direction with respect to the inner panel (20); and a door beam (40) provided between the inner panel (20) and the outer panel (30) in the vehicle width direction. The inner panel (20) includes a first wall (21) extending in a front-rear direction of a vehicle body (10) on the inner side in the vehicle width direction, a second wall (22) extending from the first wall (21) toward the outer side in the vehicle width direction, and a third wall (23) extending in the front-rear direction of the vehicle body (10) from an outer end of the second wall (22) in the vehicle width direction and joined to the outer panel (30). The door beam (40) includes an arch-shaped beam body (51) in which a center (51c) in a longitudinal direction bulges toward the outer side in the vehicle width direction with respect to both ends (51a, 51b), and a stay (61) located on the outer side in the vehicle width direction with respect to the end (51b) of the beam body (51) in the longitudinal direction. At least one end (51b) of the beam body (51) is fixed to the first wall (21), and the stay (61) has one end (61a) fixed to the beam body (51) and the other end (61b) fixed to the third wall (23).

### BRIEF DESCRIPTION OF THE DRAWINGS

FIG. 1 is a view showing a part of the side surface of the vehicle body to which the door structure for vehicle according to an embodiment of the disclosure is applied.

FIG. 2 is a schematic perspective view of the door beam as viewed from above.

FIG. 3 is a view showing a cross section taken along the line X-X of FIG. 1.

FIG. 4 is a view showing a detailed configuration of the rear end of the door beam and the surrounding area thereof, and is a partially enlarged view of the portion Y of FIG. 2.

FIG. 5 is a view showing a cross section taken along the line Z-Z of FIG. 4.

### DESCRIPTION OF THE EMBODIMENTS

In view of the above, the disclosure provides a door structure for vehicle, which is capable of sufficiently increasing the reaction force of a door beam against the load of a collision when the load acts on the door beam while having a relatively simple structure, thereby suppressing the deterioration of traffic smoothness while improving the traffic safety of the vehicle.

In view of the above, a door structure for vehicle according to the disclosure includes an inner panel (20) provided on an inner side in a vehicle width direction; an outer panel (30) provided on an outer side in the vehicle width direction with respect to the inner panel (20); and a door beam (40) provided between the inner panel (20) and the outer panel (30) in the vehicle width direction. The inner panel (20) includes a first wall (21) extending in a front-rear direction of a vehicle body (10) on the inner side in the vehicle width direction, a second wall (22) extending from the first wall (21) toward the outer side in the vehicle width direction, and a third wall (23) extending in the front-rear direction of the vehicle body (10) from an outer end of the second wall (22) in the vehicle width direction and joined to the outer panel (30). The door beam (40) includes an arch-shaped beam body (51) in which a center (51c) in a longitudinal direction bulges toward the outer side in the vehicle width direction with respect to both ends (51a, 51b), and a stay (61) located on the outer side in the vehicle width direction with respect to the end (51b) of the beam body (51) in the longitudinal direction. At least one end (51b) of the beam body (51) is fixed to the first wall (21), and the stay (61) has one end (61a) fixed to the beam body (51) and the other end (61b) fixed to the third wall (23).

According to the door structure for vehicle of the disclosure, the end of the beam body is fixed to the first wall, and one end of the stay is fixed to the beam body and the other end is fixed to the third wall, which forms the structure in which the end of the beam body is sandwiched between the stay of the door beam and the first wall of the inner panel. Thus, when the load of a collision (side impact) acts on or near the center of the door beam in the longitudinal direction, it is possible to prevent the door beam from being displaced in the rotational direction around the end thereof. Thus, it is possible to prevent the bending moment acting on the door beam from increasing, so the reaction force of the door beam against the load can be sufficiently increased.

Further, in this door structure, at least a part of a cross section of the stay (61) in the longitudinal direction may be formed in a substantially C shape that is convex toward the outer side in the vehicle width direction.

According to this configuration, the cross section of the stay in the longitudinal direction has a substantially C shape, which can increase the rigidity of the stay. Therefore, when the load of a collision (side impact) acts on the center of the door beam, it is possible to more reliably prevent the end of the door beam from being displaced in the rotational direction.

Further, in this door structure, the substantially C-shaped cross section of the stay (61) may be formed continuously from the one end (61a) to the other end (61b) of the stay (61).

According to this configuration, the substantially C-shaped cross section of the stay is formed continuously from one end to the other end of the stay, which provides a substantially C-shaped cross section with high rigidity across the beam body of the door beam and the third wall joined to the outer panel, making it possible to more reliably prevent the end of the door beam from be displaced in the rotational direction.

Further, in this door structure, at least a cross section of a portion, to which the stay (61) is connected, of the beam body (51) may be formed in a substantially C shape that is convex toward the outer side in the vehicle width direction, and the substantially C-shaped cross section of the stay (61) and the substantially C-shaped cross section of the beam body (51) may be arranged to overlap each other.

According to this configuration, the substantially C-shaped cross section of the stay in the door beam and the substantially C-shaped cross section of the beam body are arranged so as to overlap each other, which can also suppress relative displacement between the stay and the beam body in the up-down direction. Therefore, in combination with suppression of the displacement of the end of the door beam in the rotational direction, the reaction force of the door beam can be further increased.

Further, this door structure may further include a bracket (28) connecting and fixing the end (51b) of the beam body (51) and the other end (61b) of the stay (61).

According to this configuration, the end of the beam body and the other end of the stay are connected by the bracket, which forms a triangular support structure (truss structure) by (the arch portion of) the beam body, the stay, and the bracket. Therefore, when the load due to a collision is input to or near the central portion of the door beam in the longitudinal direction, it is possible to suppress the reduction in the distance between the end of the beam body and the end of the stay. Thus, the rigidity of the door beam can be more reliably increased.

It should be noted that the above signs in parentheses indicate the drawing reference numerals of corresponding constituent elements in the embodiments described later for reference.

With the door structure for vehicle according to the disclosure, it is possible to sufficiently increase the reaction force of the door beam against the load of a collision when the load acts on the door beam while having a relatively simple structure, and to suppress the deterioration of traffic smoothness while improving the traffic safety of the vehicle.

Hereinafter, embodiments of the disclosure will be described in detail with reference to the accompanying drawings. In the following description, the term “front” or “rear” refers to the front side that is the forward direction or the rear side that is the rearward direction of a vehicle body (vehicle), which will be described later. In addition, the terms “left” and “right” respectively refer to the left and right in the vehicle width direction in a state of facing the forward direction (front side) of the vehicle body (vehicle). Further, the terms “up” and “down” refer to the up-down direction (vertical up-down direction) of the vehicle body (vehicle).

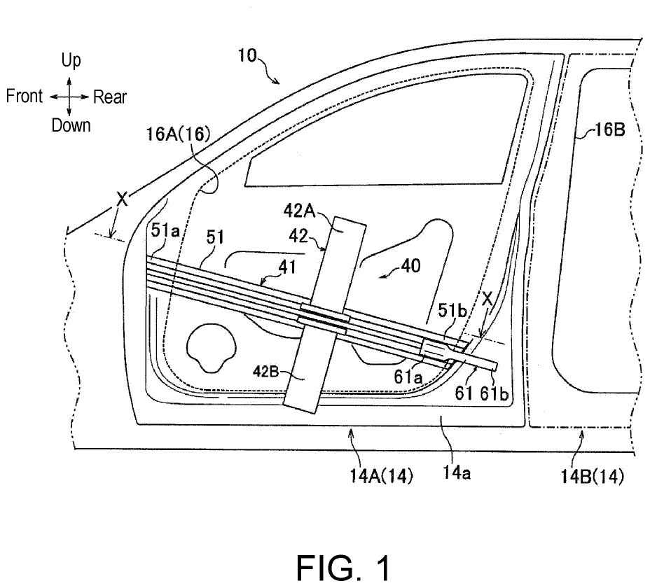

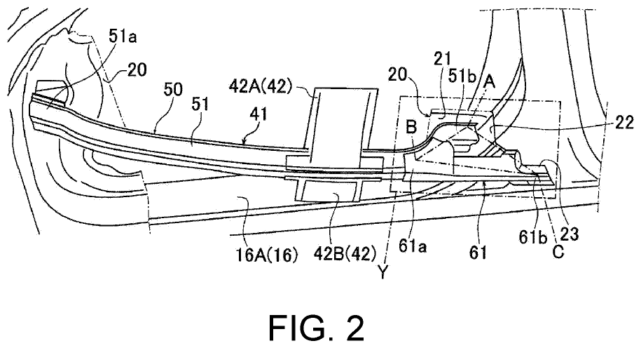

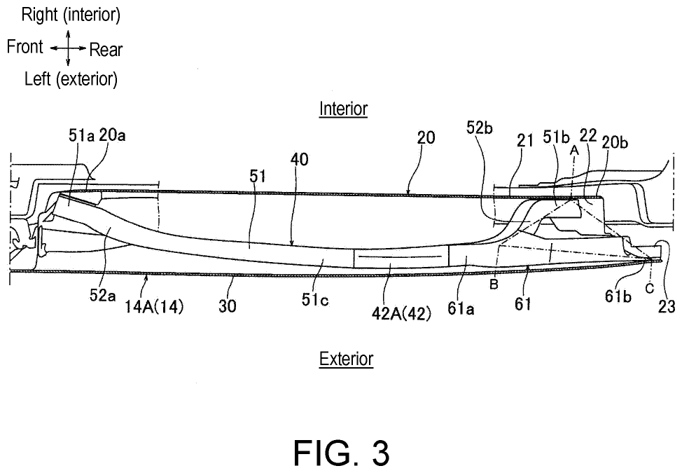

FIG. 1 is a view showing a part of a side surface of a vehicle body to which a door structure for vehicle according to an embodiment of the disclosure is applied, and FIG. 2 is a schematic perspective view of a door beam as viewed from above. In addition, FIG. 3 is a view showing a cross section taken along the line X-X of FIG. 1. As shown in these drawings, the vehicle to which the door structure according to an embodiment of the disclosure is applied includes a side door 14 provided on the vehicle body 10. The side door 14 is composed of a front door 14A and a rear door 14B. Further, the vehicle body 10 is provided with a door opening 16 on which the side door 14 is mounted so as to be opened and closed. The door opening 16 has a front door opening 16A and a rear door opening 16B. In the following description, only the front door 14A of the side door 14 and the front door opening 16A of the door opening 16 will be described, and the description of the rear door 14B and the rear door opening 16B will be omitted.

The front door 14A is composed of a door body 14a that opens and closes the front door opening 16A. As shown in FIG. 3, the door body 14a of the front door 14A includes an inner panel 20 provided on the inner side in the vehicle width direction, an outer panel 30 provided on the outer side in the vehicle width direction with respect to the inner panel 20, and a door beam provided between the inner panel 20 and the outer panel 30 in the vehicle width direction. The inner panel 20 and the outer panel 30 are plate-shaped members made of metal, and the door beam 40 is an elongated member made of metal.

The door beam 40 is composed of a horizontal beam 41 disposed inside the door body 14a of the front door 14A and extending along the front-rear direction of the vehicle body 10, and a vertical beam 42 also disposed inside the door body 14a and extending along the up-down direction of the vehicle body 10.

The horizontal beam 41 has a curved shape (bulging shape) in which the middle portion in the longitudinal direction bulges toward the outer side in the vehicle width direction in the plan view. The vertical beam 42 is joined to a portion of the horizontal beam 41 that bulges most toward the outer side in the vehicle width direction in the plan view. The vertical beam 42 is composed of an upper vertical beam 42A extending upward from the horizontal beam 41 and a lower vertical beam 42B extending downward from the horizontal beam 41.

As shown in FIG. 3, a front end 51a of the horizontal beam 41 (beam body 51 which will be described later) is fixed to a front portion 20a of the inner panel 20. Further, a rear end 51b of the horizontal beam 41 (beam body 51) is fixed to the lower side of a rear portion 20b of the inner panel 20.

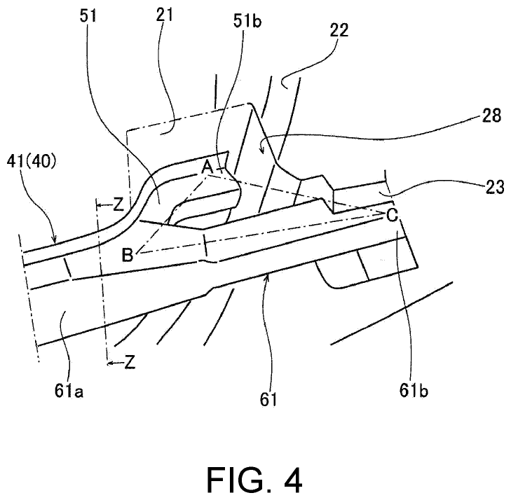

FIG. 4 is a view showing a detailed configuration of the rear end of the door beam (horizontal beam) and the surrounding area thereof, and is a partially enlarged view of the portion Y of FIG. 2. In the door structure of this embodiment, the inner panel 20 has an inner wall (first wall) 21 extending in the front-rear direction of the vehicle body 10 on the inner side in the vehicle width direction, a connection wall (second wall) 22 extending from the inner wall 21 toward the outer side in the vehicle width direction, and an outer wall (third wall) 23 extending in the front-rear direction of the vehicle body 10 from an outer end of the connection wall 22 in the vehicle width direction and joined to the outer panel 30. The inner wall 21 is a portion forming the inner side of the inner panel 20 excluding the outer edge (peripheral edge), the outer wall 23 is a portion forming the outer edge (peripheral edge) of the inner panel 20, and the inner wall 21 and the outer wall 23 are respectively arranged in a plane located on the inner side (the right side in FIG. 3 or the interior side) and in a plane located on the outer side (the left side in FIG. 3 or the exterior side) in the vehicle width direction. Then, the connection wall 22 connects the inner wall 21 and the outer wall 23 with a step in the vehicle width direction.

The horizontal beam 41 of the door beam 40 includes an arch-shaped beam body 51 in which a central portion 51c in the longitudinal direction bulges toward the outer side in the vehicle width direction with respect to the front end 51a and the rear end 51b, and a stay 61 connected to the vicinity of the rear end 51b of the beam body 51. The beam body 51 is an elongated member having a substantially C-shaped (U-shaped) cross section that is convex toward the outer side in the vehicle width direction, the front end 51a and the rear end 51b are fixed portions fixed to the inner panel 20, and the vicinities of the front end 51a and the rear end 51b are respectively a front curved portion 52a and a rear curved portion 52b that curve toward the outer side in the vehicle width direction, so that the central portion 51c in the longitudinal direction has a shape that bulges toward the outer side in the vehicle width direction. The stay 61 is also an elongated member having a substantially C-shaped (U-shaped) cross section that is convex toward the outer side in the vehicle width direction, and the entire stay 61 in the longitudinal direction from the front end 61a to the rear end 61b is formed in a substantially linear shape. In this embodiment, the entire cross sections of the beam body 51 and the stay 61 in the longitudinal direction are both formed in a substantially C shape.

As shown in FIG. 3, the rear end 51b of the beam body 51 is fixed to the inner wall 21 of the inner panel 20. The front end (one end) 61a of the stay 61 is fixed to a position of the beam body 51 on the front side with respect to the rear end 51b and the rear curved portion 52b, and the rear end (the other end) 61b is fixed to the outer wall 23 of the inner panel 20. Further, as shown in FIG. 4, a bracket 28 is provided for connecting and fixing the rear end 51b of the beam body 51 and the rear end 61b of the stay 61. The bracket 28 is a plate-shaped member made of metal, and is interposed between the rear end 51b of the beam body 51 and the inner wall 21 of the inner panel 20, and is also interposed between the rear end 61b of the stay 61 and the outer wall 23 of the inner panel 20. That is, the rear end 51b of the beam body 51 is fixed to the inner wall 21 of the inner panel 20 via the bracket 28, and the rear end 61b of the stay 61 is also fixed to the outer wall 23 of the inner panel 20 via the same bracket 28.

Then, as shown in FIG. 3, a triangular shape is formed with three fixing portions A, B, and C as vertices, wherein the first fixing portion A is where the rear end 51b of the beam body 51 is fixed to the inner wall 21 of the inner panel 20, the second fixing portion B is where the front end 61a of the stay 61 is fixed to the beam body 51, and the third fixing portion C is where the rear end 61b of the stay 61 is fixed to the inner wall 21 of the inner panel 20. That is, the fixing structure (support structure) on the rear side of the door beam 40 (horizontal beam 41) is a triangular support structure (truss structure) formed by these three fixing portions A, B, and C.

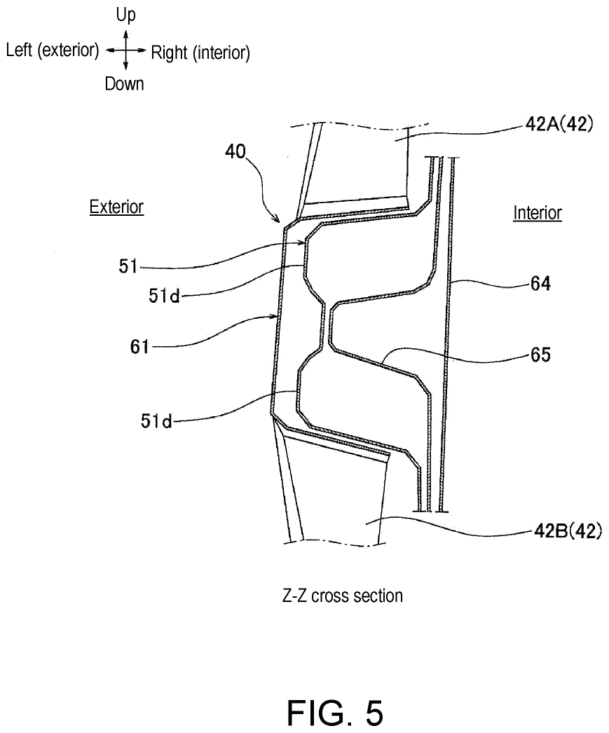

In addition, as shown in FIG. 5, in the portion where the front end 61a of the stay 61 is fixed to the beam body 51, the substantially C-shaped cross section of the beam body 51 is arranged to overlap on the inner side of the substantially C-shaped cross section of the stay 61. That is, in the portion where the beam body 51 and the stay 61 are connected, the substantially C-shaped cross section of the stay 61 and the substantially C-shaped cross section of the beam body 51 are arranged to overlap each other. In FIG. 5, the sign 64 denotes a back plate arranged on the inner side of the beam body 51 in the vehicle width direction, and the sign 65 denotes a stiffener as a reinforcing member interposed between the beam body 51 and the back plate 64. Further, more specifically, as shown in FIG. 5, as the cross section of the beam body 51 has two bulging portions 51d arranged on top of each other vertically, the entire cross section is formed in a substantially M shape sideways (a so-called hat shape).

As described above, the door body 14a of the front door 14A having the door structure for vehicle of this embodiment includes the inner panel 20 provided on the inner side in the vehicle width direction, the outer panel 30 provided on the outer side in the vehicle width direction with respect to the inner panel 20, and the door beam 40 provided between the inner panel 20 and the outer panel 30 in the vehicle width direction. Then, the inner panel 20 includes the inner wall (first wall) 21 extending in the front-rear direction of the vehicle body 10 on the inner side in the vehicle width direction, the connection wall (second wall) 22 extending from the inner wall 21 toward the outer side in the vehicle width direction, and the outer wall (third wall) 23 extending in the front-rear direction of the vehicle body 10 from the outer end of the connection wall (second wall) 22 in the vehicle width direction and joined to the outer panel 30. Further, the door beam includes the arch-shaped beam body 51 in which the central portion 51c in the longitudinal direction bulges toward the outer side in the vehicle width direction with respect to the front end 51a and the rear end 51b, and the stay 61 located on the outer side in the vehicle width direction with respect to the rear end 51b of the beam body 51 in the longitudinal direction. Then, the rear end 51b of the beam body 51 is fixed to the inner wall 21 of the inner panel 20, and the front end 61a of the stay 61 is fixed to the beam body 51 and the rear end 61b is fixed to the outer wall 23 of the inner panel 20.

According to the door structure for vehicle of this embodiment, the rear end 51b of the beam body 51 is fixed to the inner wall 21 of the inner panel 20, and the front end 61a of the stay 61 is fixed to the beam body 51 and the rear end 61b is fixed to the outer wall 23 of the inner panel 20, so that it forms a structure in which the rear end 51b of the beam body 51 is sandwiched between the stay 61 of the door beam 40 and the inner wall 21 of the inner panel 20. Thus, when the load of a collision (side impact) acts on or near the central portion 51c of the door beam 40 in the longitudinal direction, it is possible to prevent the door beam 40 (beam body 51) from being displaced in the rotational direction around the rear end 51b thereof. Accordingly, it is possible to prevent the bending moment acting on the door beam 40 from increasing, so the reaction force of the door beam 40 against the load can be sufficiently increased.

In addition, in this door structure, the cross section of the stay 61 in the longitudinal direction is formed in a substantially C shape that is convex toward the outer side in the vehicle width direction, thereby increasing the rigidity of the stay 61. Therefore, when the load of a collision (side impact) acts on or near the central portion 51c of the door beam 40 (beam body 51), it is possible to more reliably prevent the rear end 51b of the door beam 40 (beam body 51) from being displaced in the rotational direction.

Furthermore, the substantially C-shaped cross section of the stay 61 is formed continuously from the front end 61a to the rear end 61b of the stay 61, which provides a substantially C-shaped cross section with high rigidity across the beam body 51 of the door beam and the outer wall 23 of the inner panel 20 joined to the outer panel 30, making it possible to more reliably prevent the rear end 51b of the door beam 40 (beam body 51) from being displaced in the rotational direction.

In addition, in this door structure, the cross section of the portion (second fixing portion B) of the beam body 51, to which the stay 61 is connected, is formed in a substantially C shape that is convex toward the outer side in the vehicle width direction, and in that portion, the substantially C-shaped cross section of the stay 61 and the substantially C-shaped cross section of the beam body 51 are arranged to overlap each other.

According to this configuration, since relative displacement between the stay 61 and the beam body 51 in the up-down direction can also be suppressed, in combination with suppression of the displacement of the rear end 51b of the door beam 40 (beam body) 51 in the rotational direction, the reaction force of the door beam 40 can be further increased.

Moreover, in this door structure, the bracket 28 is provided for connecting and fixing the rear end 51b of the beam body 51 and the rear end 61b of the stay 61, so the rear end 51b of the beam body 51 and the rear end 61b of the stay 61 are connected and fixed by the bracket 28. Thus, a triangular support structure (truss structure) is formed by (the arch portion of) the beam body 51, the stay 61, and the bracket 28. Therefore, when the load due to a collision (side impact) is input to or near the central portion 51c of the door beam 40 (beam body 51) in the longitudinal direction, reduction in the distance between the rear end 51b of the beam body 51 and the rear end 61b of the stay 61 can be suppressed. Thus, the rigidity of the door beam 40 can be more reliably increased.

Although the embodiments of the disclosure have been described above, the disclosure is not limited to the above embodiments, and various modifications are possible within the scope of the technical ideas described in the claims, specification, and drawings. For example, the above embodiment illustrates a case where the entire cross sections of the beam body 51 and the stay 61 in the longitudinal direction have a substantially C shape, but the disclosure is not limited thereto, and only a part of the beam body 51 and the stay 61 may have a substantially C-shaped cross section.

What is claimed is:

1. A door structure for vehicle, comprising:
an inner panel provided on an inner side in a vehicle width direction;
an outer panel provided on an outer side in the vehicle width direction with respect to the inner panel; and
a door beam provided between the inner panel and the outer panel in the vehicle width direction,
wherein the inner panel comprises a first wall extending in a front-rear direction of a vehicle body on the inner side in the vehicle width direction, a second wall extending from the first wall toward the outer side in the vehicle width direction, and a third wall extending in the front-rear direction of the vehicle body from an outer end of the second wall in the vehicle width direction and joined to the outer panel,
the door beam comprises an arch-shaped beam body in which a center in a longitudinal direction bulges toward the outer side in the vehicle width direction with respect to both ends, and a stay located on the outer side in the vehicle width direction with respect to the end of the beam body in the longitudinal direction,
at least one end of the beam body is fixed to the first wall, and
the stay has one end fixed to the beam body and the other end fixed to the third wall.

2. The door structure for vehicle according to claim 1, wherein at least a part of a cross section of the stay in the longitudinal direction is formed in a substantially C shape that is convex toward the outer side in the vehicle width direction.

3. The door structure for vehicle according to claim 2, wherein the substantially C-shaped cross section of the stay is formed continuously from the one end to the other end of the stay.

4. The door structure for vehicle according to claim 2, wherein at least a cross section of a portion, to which the stay is connected, of the beam body is formed in a substantially C shape that is convex toward the outer side in the vehicle width direction, and
the substantially C-shaped cross section of the stay and the substantially C-shaped cross section of the beam body are arranged to overlap each other.

5. The door structure for vehicle according to claim 3, wherein at least a cross section of a portion, to which the stay is connected, of the beam body is formed in a substantially C shape that is convex toward the outer side in the vehicle width direction, and
the substantially C-shaped cross section of the stay and the substantially C-shaped cross section of the beam body are arranged to overlap each other.

6. The door structure for vehicle according to claim 1, further comprising a bracket connecting and fixing the end of the beam body and the other end of the stay.

7. The door structure for vehicle according to claim 2, further comprising a bracket connecting and fixing the end of the beam body and the other end of the stay.

8. The door structure for vehicle according to claim 3, further comprising a bracket connecting and fixing the end of the beam body and the other end of the stay.

9. The door structure for vehicle according to claim 4, further comprising a bracket connecting and fixing the end of the beam body and the other end of the stay.

10. The door structure for vehicle according to claim 5, further comprising a bracket connecting and fixing the end of the beam body and the other end of the stay.
